(19) United States
(12) Patent Application Publication
(10) Pub. No.: US 2002/0033925 A1
(43) Pub. Date: Mar. 21, 2002

(54) Liquid crystal display device and electronic apparatus

(75) Inventor: Akihiko Ito, Tatsuno-cho (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 09/949,664

(22) Filed: Sep. 12, 2001

(30) Foreign Application Priority Data
Sep. 12, 2000 (JP) 2000-277210

(51) Int. Cl. G02F 1/1343

(52) U.S. Cl. 349/145

(57) ABSTRACT

The invention provides a reflective liquid crystal display device of a multiple matrix type in which display unevenness is prevented and the image quality is enhanced. A reflective liquid crystal display device of a multiple matrix type of the present invention includes a plurality of rows of common electrodes, and a plurality of columns of segment electrodes provided so as to be orthogonal thereto, each segment electrode including a plurality of pixel electrodes arranged in a column, and wiring sections connecting every predetermined number of the pixel electrodes to each other. In the wiring section, a second wiring section, located between two adjacent pixel electrodes in the extending direction of the common electrode, is placed at an equal distance from the two pixel electrodes, and the second wiring sections, ranging in the extending direction of the segment electrode at the area between the two adjacent columns of segment electrodes, are arranged substantially in a line.

### BACKGROUND OF THE INVENTION

1. Field of Invention

The present invention relates to liquid crystal display devices and electronic apparatuses, and more particularly, the invention relates to a reflective liquid crystal display device of a multiple matrix type.

2. Description of Related Art

In twisted nematic liquid crystals, etc., which have been conventionally used in liquid crystal display devices, since sharp threshold characteristics are not exhibited and it is difficult to perform multiplex driving (time-division driving) on a large scale, the number of time divisions (referred to as “duty”), that is, the number of scanning lines, is limited. Therefore, in order to increase the size of the screen and to enhance the image quality, a multiple matrix method has been proposed in which the number of signal electrodes corresponding to one scanning electrode is set to be twice (double matrix), three times (triple matrix), etc., so that resolution is enhanced compared to the simple matrix method in which one signal electrode corresponds to one scanning electrode. When the multiple matrix method is employed, it is possible to decrease the duty compared to the case in which the simple matrix method is employed with the same number of pixels, and therefore it is possible to decrease the driving voltage and driving frequency, resulting in a reduction in electrical power consumption.

FIG. 10 is a plan view showing the electrode configuration of a double matrix liquid crystal display device. As shown in FIG. 10, a plurality of strip-shaped common electrodes 101 extends horizontally, and a plurality of segment electrodes 102 extends vertically so as to be orthogonal thereto. Each segment electrode 102 includes a plurality of pixel electrodes 103 vertically arranged and wiring sections 104 connecting every other pixel electrode 103 to each other. For one common electrode 101 row, the pixel electrodes 103 and the wiring sections 104 of two adjacent segment electrodes constitute two pixels.

Recently, since liquid crystal display devices are increasingly used for mobile electronic apparatuses, such as mobile phones, wristwatches, and notebook computers, demands for reduction in size and weight as well as reduction in electric power consumption are increasing, and in such a case, reflective liquid crystal display devices are often used. FIGS. 11 and 12 are sectional views taken along plane A-A′ of FIG. 10, in which the double matrix liquid crystal display device is used as a reflective liquid crystal display device. As shown in FIGS. 1 1 and 12, a liquid crystal layer 113 is enclosed in a space surrounded by a pair of transparent substrates 110 and 111 and a sealing member 112. A retardation film 114 and a polarizer 115 are bonded in that order to the outer surface of the upper substrate 110, and a polarizer 116 and a reflector 117 are bonded in that order to the outer surface of the lower substrate 111. The common electrodes 101 are provided on the upper substrate 110 at the side facing the liquid crystal layer 113, and the segment electrodes 102, including pixel electrodes 103 and wiring sections 104, are provided on the lower substrate 111 at the side facing the liquid crystal layer 113. An alignment film, etc., are not shown in these figures.

In the conventional reflective liquid crystal device of the multiple matrix type described above, display unevenness occurs due to the electrode configuration, thereby degrading the image quality. That is, in the liquid crystal display device having the electrode configuration as shown in FIG. 10, when incident light L₁ or L₂ falls on the wiring section 104 and its vicinity (between the wiring section 104 and the pixel electrode 103 of the segment electrode 102), a shadow is reflected in the pixel performing display, resulting in line display unevenness, thereby degrading the image quality.

For example, when a voltage is applied to the liquid crystal layer directly above the wiring section 104 by supplying an image signal to the segment electrode, if the device is in a mode in which black display is performed in the presence of the applied voltage, as shown in FIG. 11, black (indicated by oblique lines) is displayed in the region of the wiring section 104, and white is displayed at both sides thereof. Since the region of the black display itself directly above the wiring section is very small, it is not very noticeable by direct visual observation. However, in the case of the reflective liquid crystal display device, since outside light enters from every direction, light entering the liquid crystal panel obliquely, as indicated by line L₁, is reflected from the surface of the reflector 117, and follows the path shown in FIG. 11 to reach a user's eyes. Consequently, when white display is performed in a pixel 105a to perform display in the vicinity of the wiring section, the black display portion directly above the wiring section is indirectly reflected in the pixel 105a as a shadow via the path described above, thus affecting the display.

When all the pixels are set to perform black display, as shown in FIG. 12, outside light L₂ transmitted between the wiring section and the pixel electrode is reflected from the reflector 117 and enters the pixel of black display, resulting in reflection, and thus the display is affected. Additionally, when the wiring section 104 is formed of a transparent conductive film, such as indium tin oxide (hereinafter referred to as ITO), a shadow occurs in the pixel due to the behavior described above. When the wiring section 104 is formed of an opaque film, such as a metallic material, the shadow of the wiring section occurs substantially independently of the applied voltage.

Moreover, as for the wiring section, which is indicated by oblique lines in FIG. 10, between two horizontally adjacent pixel electrodes 103 (in the extending direction of the common electrode), in the width of one common electrode 101 row, the wiring section 104 located between pixel electrodes 103 in the upper stage and the wiring section 104 located between pixel electrodes 103 in the lower stage are arranged so as to be alternately shifted in the extending direction of the common electrode 101 (so that the wiring section 104 located between pixel electrodes 103 in the upper stage and the wiring section 104 located between pixel electrodes 103 in the lower stage are not arranged in a line in the extending direction of the segment electrode 102). Therefore, a remarkable difference occurs in the influence of shadows on the display pixels, and strong line display unevenness occurring in the extending direction of the common electrode is visible.

### SUMMARY OF THE INVENTION

The present invention has been achieved to overcome the problems described above. It is an object of the present invention to provide a reflective liquid crystal display device of a multiple matrix type in which display unevenness is prevented and the image quality is enhanced.

In one aspect of the present invention, a liquid crystal display device of a multiple matrix type includes a liquid crystal interposed between a pair of substrates opposed to each other; a plurality of rows of common electrodes provided on one of the substrates; and a plurality of columns of segment electrodes provided on the other substrate so as to be cross to the plurality of rows of common electrodes. Each segment electrode includes a plurality of pixel electrodes and wiring sections connecting every predetermined number of the pixel electrodes to each other. A plurality of pixel electrodes face one common electrode row which is arranged in the width direction of the one common electrode row so as to form displaying pixels. A reflecting layer is provided on an outer surface of either one of the substrates, and the wiring sections of the segment electrode include a plurality of inter-pixel electrode wiring sections. Each inter-pixel electrode wiring section is placed between two adjacent pixel electrodes in the extending direction at a substantially equal distance from the two adjacent pixel electrodes. The plurality of inter-pixel electrode wiring sections are arranged substantially in a line in a direction substantially orthogonal to the extending direction of the common electrodes.

In another aspect of the present invention, a liquid crystal display device of a multiple matrix type includes a liquid crystal interposed between a pair of substrates opposed to each other; a plurality of rows of common electrodes provided on one of the substrates; and a plurality of columns of segment electrodes provided on the other substrate so as to be cross to the plurality of rows of common electrodes. Each segment electrode includes a plurality of pixel electrodes and wiring sections connecting every predetermined number of the pixel electrodes to each other. A plurality of pixel electrodes face one common electrode row which is arranged in the width direction of the one common electrode row so as to form displaying pixels. A reflecting layer is provided on an outer surface of either one of the substrates, and the wiring sections of the segment electrode include a plurality of inter-pixel electrode wiring sections. Each inter-pixel electrode wiring section is placed between two adjacent pixel electrodes in the extending direction at a substantially equal distance from the two adjacent pixel electrodes. The plurality of inter-pixel electrode wiring sections share an overlapping width in a direction substantially orthogonal to the extending direction of the common electrodes.

In the liquid crystal display device of the present invention, the wiring sections of the segment electrode include a plurality of inter-pixel electrode wiring sections. Each inter-pixel electrode wiring section is placed between two adjacent pixel electrodes in the extending direction at a substantially equal distance from the two adjacent pixel electrodes. The plurality of inter-pixel electrode wiring sections is arranged substantially in a line in a direction substantially orthogonal to the extending direction of the common electrodes. Alternatively, the plurality of inter-pixel electrode wiring sections shares an overlapping width in a direction substantially orthogonal to the extending direction of the common electrodes. Consequently, in a plurality of pixels corresponding to one common electrode row, there is no difference in the influence of shadows of the wiring sections on the individual pixels, and the influence of shadows on the individual pixels is uniform in all directions. As a result, it is possible to prevent line display unevenness from occurring in the extending direction of the common electrode, and a liquid crystal display device having satisfactory image quality can be obtained.

Preferably, some of the pixel electrodes are placed so as to spread over two rows of common electrodes.

In the multiple matrix method, unless the common electrodes and the segment electrodes are aligned accurately, the area in which a normal image is displayed is reduced, and the possibility of a false image appearing in a section deviating by one row from the correct section is increased. As a result, the contrast ratio of the image is decreased and the resolution is degraded. If the structure described above is used, even if there is a slight misalignment between the common electrodes and the segment electrodes, such a phenomenon can be prevented and a good quality image can be maintained.

In another aspect of the present invention, an electronic apparatus includes the liquid crystal display device of the present invention. In accordance with the present invention, it is possible to produce an electronic apparatus provided with a display area having satisfactory image quality with substantially no display unevenness.

### BRIEF DESCRIPTION OF THE DRAWINGS

FIG. 1 is a perspective view showing the arrangement and configuration of various electrodes and wiring in a liquid crystal display device in a first embodiment of the present invention;

FIG. 2 is an enlarged perspective view showing two inter-pixel electrode wiring sections placed in the extending direction of the segment electrode (in the vertical direction) in the first embodiment of the present invention;

FIG. 3 is a perspective plan view showing the arrangement and configuration of various electrodes and wiring in a liquid crystal display device in a second embodiment of the present invention;

FIG. 4 is an enlarged perspective view showing two inter-pixel electrode wiring sections placed in the extending direction of the segment electrode (in the vertical direction) in the second embodiment of the present invention;

FIG. 5 is a perspective view showing the arrangement and configuration of various electrodes and wiring in a liquid crystal display device in a third embodiment of the present invention;

FIG. 6 is an enlarged perspective view showing two inter-pixel electrode wiring sections placed in the extending direction of a segment electrode (in the vertical direction) in the third embodiment of the present invention;

FIG. 7 is a perspective view showing an electronic apparatus provided with the liquid crystal display device according to any one of the embodiments of the invention;

FIG. 8 is a perspective view showing another electronic apparatus provided with the liquid crystal display device according to any one of the embodiments of the invention;

FIG. 9 is a perspective view showing still another electronic apparatus provided with the liquid crystal display device according to any one of the embodiments of the invention;

FIG. 10 is a plan view showing the electrode configuration of a conventional double matrix liquid crystal display device;

FIG. 11 is a side view of the liquid crystal display device shown in FIG. 10 taken along plane A-A′, illustrating the path of incident outside light when the wiring sections are set to perform a black display;

FIG. 12 is a side view of the liquid crystal display device shown in FIG. 10 taken along plane A-A′, illustrating the path of incident outside light when all the pixels are set to perform a black display.

### DETAILED DESCRIPTION OF PREFERRED EMBODIMENTS

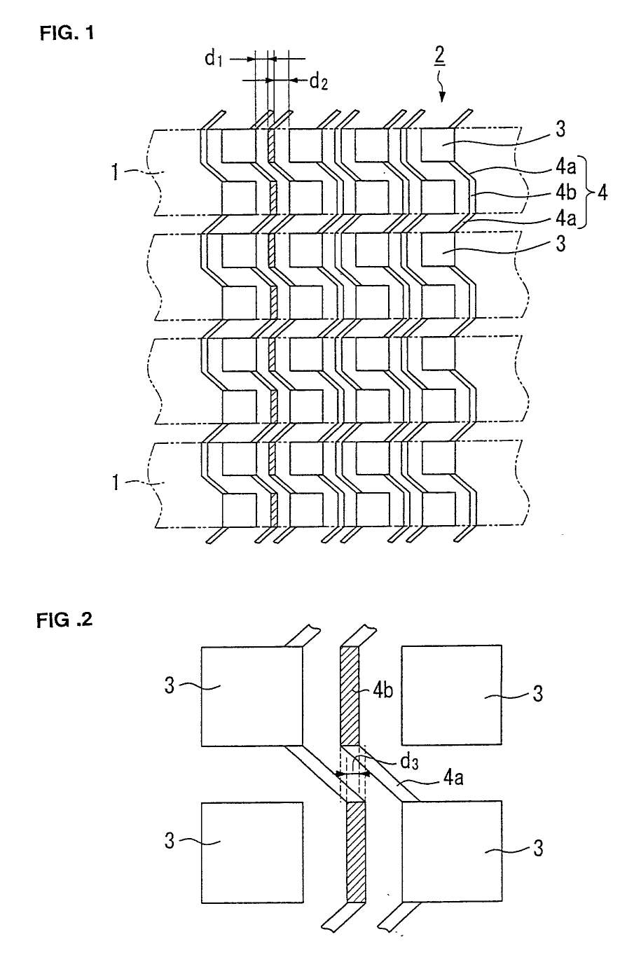

A first embodiment of the present invention will be described with reference to FIGS. 1 and 2.

FIG. 1 is a perspective view showing the electrode configuration of a liquid crystal display device in this embodiment. FIG. 2 is an enlarged perspective view showing two wiring sections between pixel electrodes placed in the extending direction of a segment electrode 2 (in the vertical direction). A double matrix example will be described in this embodiment. The liquid crystal display device is characterized by the arrangement and configuration of various electrodes and wiring sections, and since the overall structure of the liquid crystal display device is the same as the conventional device shown in FIG. 11, the sectional view thereof is omitted.

In the liquid crystal display device in this embodiment, as shown in FIG. 1, a plurality of rows of strip-shaped common electrodes 1 extend horizontally on an opposed surface of one substrate, and a plurality of columns of segment electrodes 2 extend vertically so as to be orthogonal thereto on an opposed surface of the other substrate. In FIG. 1, only four rows of common electrodes 1 and four columns of segment electrodes 2 are shown, and the rest is omitted. Each segment electrode 2 includes a plurality of substantially square pixel electrodes 3 arranged vertically and wiring sections 4 for connecting every other pixel electrode 3 to each other, and a double matrix is constructed in which two pixel electrodes 3 are arranged in the upper and lower sides in the width direction of one common electrode 1 row. Accordingly, the regions in which the common electrode 1 and the pixel electrodes 3 are opposed to each other form pixels. Although the pixel electrodes 3 must be formed of a transparent conductive film, such as ITO, the wiring sections 4 may be formed of a transparent conductive film or may be formed of an opaque film, such as a metallic film, in order to decrease the wiring resistance.

The configuration of the segment electrode 2 in one column will be described in detail. The wiring section 4 connecting pixel electrodes 3 to each other includes a first wiring section 4a extending obliquely in line from one corner of the pixel electrode 3, and a second wiring section 4b (inter-pixel electrode wiring section) extending vertically in the area between two adjacent pixel electrodes 3 in the extending direction of the common electrode 1 (in the horizontal direction in FIG. 1). The second wiring section 4b is located in the center between the left and right pixel electrodes 3. That is, a distance d₁ between one pixel electrode 3 and the second wiring section 4b is equal to a distance d₂ between the other pixel electrode 3 and the second wiring section 4b. By such a wiring section 4, every other pixel electrode 3 is connected so as to bypass the pixel electrode 3 therebetween, and a plurality of second wiring sections 4b is arranged substantially in a line in the extending direction of the segment electrode 2 (in the vertical direction) between the left and right pixel electrodes 3. That is, as shown in FIG. 2, a plurality of second wiring sections 4b share an overlapping width d₃ in the extending direction of the segment electrode 2 (in the vertical direction).

In the liquid crystal display device in this embodiment, the second wiring section 4b located between two adjacent pixel electrodes 3 in the extending direction of the common electrode 1 is placed at an equal distance from the two pixel electrodes 3, and the second wiring sections 4b ranging in the extending direction of the segment electrode 2 are arranged substantially in a line, or the second wiring sections 4b located between the pixel electrodes 3 share an overlapping width d₃ in the extending direction of the segment electrodes 2 (in the vertical direction). Therefore, there is no difference in the influence of the shadows of the second wiring sections 4b on the individual pixels in the individual pixel lines, and the influence of the shadows on the individual pixels is uniform in every direction. Consequently, it is possible to prevent line display unevenness from occurring in the extending direction of the common electrode 1, and thereby a liquid crystal display device with satisfactory image quality can be produced.

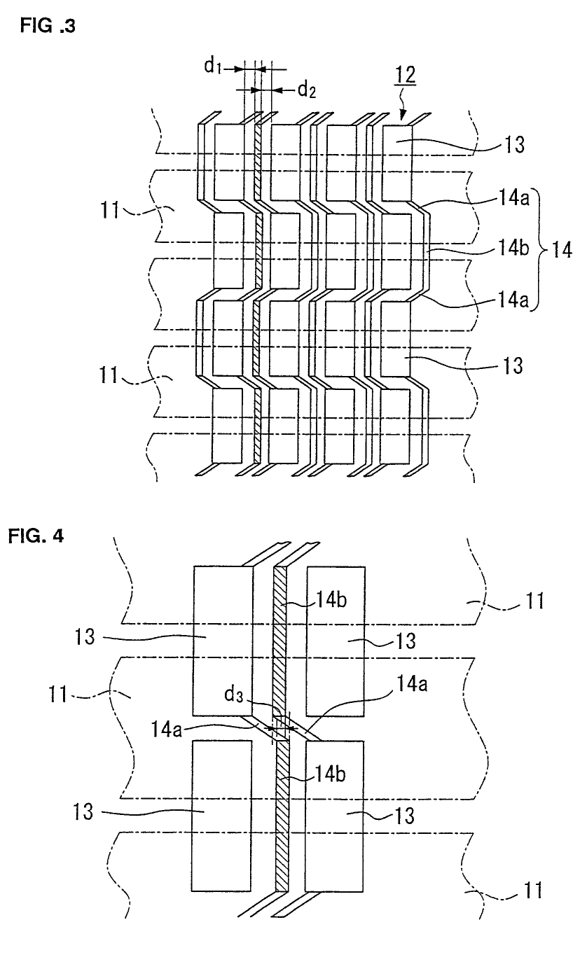

A second embodiment of the present invention will be described with reference to FIGS. 3 and 4.

FIG. 3 is a perspective view showing the arrangement and configuration of various electrodes and wiring in a liquid crystal display device in this embodiment. FIG. 4 is an enlarged perspective view showing two inter-pixel electrode wiring sections placed in the extending direction of a segment electrode 12 (in the vertical direction). A double matrix example is also described in this embodiment in the same manner as that in the first embodiment. The arrangement and configuration of the various electrodes and wiring are shown in FIGS. 3 and 4, and the sectional view thereof is omitted.

In contrast to the first embodiment, in which each common electrode formed on one substrate is opposed to two pixel electrodes placed on the other substrate, and the individual pixel electrodes are substantially square, in this embodiment, as shown in FIG. 3, two adjacent pixel electrodes, placed so as to be separated by a space between common electrodes, are combined to form a pixel electrode in a perspective view of various electrodes and wiring formed on the opposed surfaces of two substrates. That is, a substantially longitudinal rectangular pixel electrode 13 is placed so as to spread over two adjacent rows of common electrodes 11. In such a case, a plurality of segment electrodes 12 including pixel electrodes 13 and wiring sections 14 is provided so as to be orthogonal to a plurality of common electrodes 11. Each segment electrode 12 includes a plurality of longitudinal pixel electrodes 13 and wiring sections 14 that connect every other pixel electrode 13 to each other, and a double matrix is constructed in which the longitudinal pixel electrodes 13 are arranged so as to spread over the two adjacent common electrodes 11. Accordingly, in a perspective view, on one common electrode 11 row, two regions facing two pixel electrodes, placed so as to spread over the adjacent common electrodes 11, are formed in the width direction of the common electrode 11, and the two regions form displaying pixels.

The wiring section 14 that connects pixel electrodes 13 to each other has the same configuration as the first embodiment. That is, the wiring section 14 includes a first wiring section 14a extending obliquely from one corner of the pixel electrode 13, and a second wiring section 14b (inter-pixel electrode wiring section) extending in the extending direction of the segment electrode 12 (in the vertical direction in the drawing) at the area between adjacent pixel electrodes 13 in the extending direction of the common electrode 11 (in the horizontal direction in FIG. 3). The second wiring section 14b is located in the center between the left and right pixel electrodes 13 (that is, a distance d₁ between one pixel electrode 13 and the second wiring section 14b is equal to a distance d₂ between the other pixel electrode 13 and the second wiring section 14b). By such a wiring section 14, every other pixel electrode 13 is connected to each other, and a plurality of second wiring sections 14b, located between the left and right pixel electrodes 13, is arranged substantially in a line. As shown in FIG. 4, a plurality of second wiring sections 14b share an overlapping width d₃ in the extending direction of the segment electrode 12 (in the vertical direction).

In the liquid crystal display device in this embodiment, there is also no difference in the influence of the shadows of the second wiring sections 14b on the individual pixels in the individual pixel lines, and the influence of the shadows on the individual pixels is uniform in every direction. Consequently, it is possible to prevent line display unevenness, and thereby a liquid crystal display device with satisfactory image quality can be produced in the same manner as that in the first embodiment. Furthermore, in this embodiment, since the individual pixel electrodes 13 are arranged so as to spread over the upper and lower common electrodes 11, even if there is a slight misalignment between the common electrodes 11 and the segment electrodes 12, it is possible to avoid problems, such as a decrease in the contrast ratio of the image and degradation in resolution, thus maintaining a good quality image.

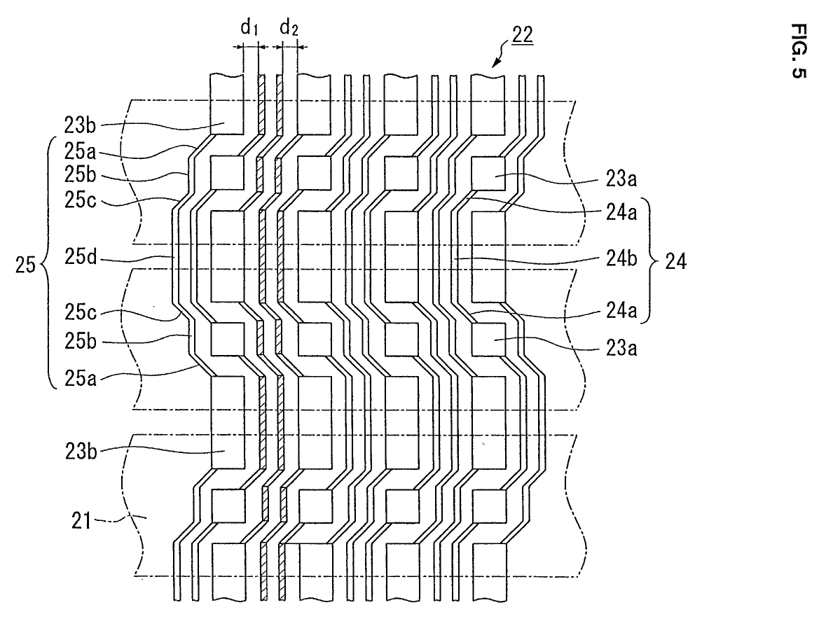

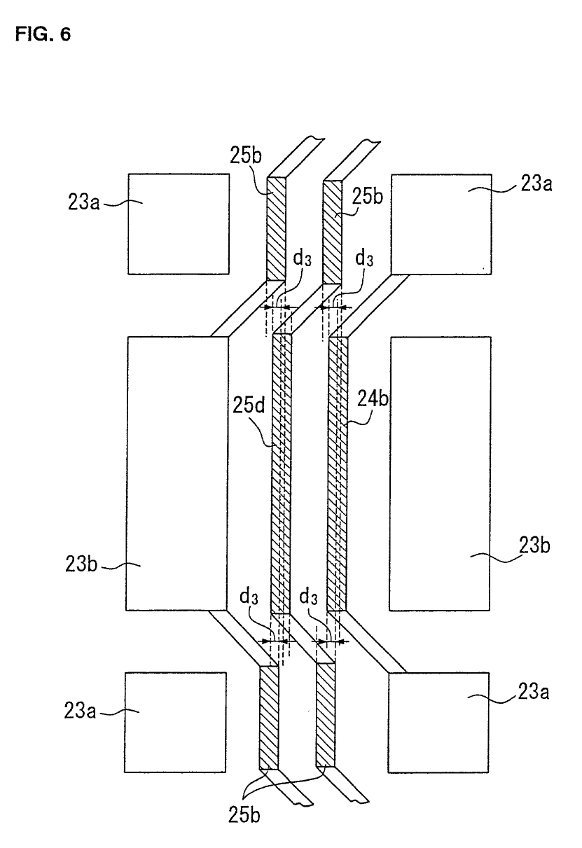

A third embodiment of the present invention will be described with reference to FIGS. 5 and 6.

FIG. 5 is a perspective view showing the arrangement and configuration of various electrodes and wiring in a liquid crystal display device in this embodiment. FIG. 6 is an enlarged perspective view showing two inter-pixel electrode wiring sections placed in the extending direction of a segment electrode 22 (in the vertical direction in the drawing). A triple matrix example is described in this embodiment. This embodiment is also characterized by the arrangement and configuration of the various electrodes and wiring, and since the overall structure of the liquid crystal display device is the same as the conventional one shown in FIG. 11, the sectional view thereof is omitted.

In the liquid crystal display device in this embodiment, as shown in FIG. 5, a plurality of rows of strip-shaped common electrodes 21 extend in the horizontal direction on an opposed surface of one substrate, and a plurality of columns of segment electrodes 22 extend in the vertical direction on an opposed surface of the other substrate. In this embodiment, each segment electrode 22, provided on the opposed surface of the other substrate, includes substantially square pixel electrodes 23a which are placed opposed to almost the center in the width direction of the common electrode 21 and substantially rectangular pixel electrodes 23b placed corresponding to the ends in the width direction of adjacent common electrodes 21 so as to spread over the adjacent common electrodes 21, the square pixel electrodes 23a and the rectangular pixel electrodes 23b being provided alternately in the extending direction of the segment electrode 22 (in the vertical direction). The substantially square pixel electrodes 23a are connected to each other by a wiring section 24, and the substantially rectangular pixel electrodes 23b are connected to each other by a wiring section 25 at an interval of three pixel electrodes (namely, so as to bypass a substantially square pixel electrode 23a, a substantially rectangular pixel electrode 23b, and a substantially square pixel electrode 23a which range therebetween). By such an electrode configuration, a triple matrix is constructed in which, for one common electrode 21 row, three pixel electrode regions are opposed in the width direction of the common electrode 21. Accordingly, in a perspective view, for one common electrode 21 row, two regions, opposed to two substantially rectangular pixel electrodes 23b to spread over the adjacent common electrodes 21, are formed on the ends in the width direction of the one common electrode 21 row, and a region opposed to the substantially square pixel electrode 23a is formed almost at the center in the width direction. The three regions form displaying pixels.

In this embodiment, wiring sections 24 and 25, two in total, are arranged between substantially square pixel electrodes 23a placed in the extending direction of the common electrode 21 (in the horizontal direction in FIG. 5) and between substantially rectangular pixel electrodes 23b, respectively. Each wiring section 24 that connects substantially square pixel electrodes 23a to each other includes a first wiring section 24a extending obliquely from one corner of the substantially square pixel electrode 23a, and a second wiring section 24b (inter-pixel electrode wiring section) extending in line in a direction substantially orthogonal to the direction of the common electrode 21 (in the vertical direction in FIG. 5) at the area between the substantially rectangular pixel electrodes 23b, in the same manner as in the previous embodiment. Each wiring section 25 that connects substantially rectangular pixel electrodes 23b includes a first wiring section 25a extending obliquely in line from one corner of the rectangular pixel electrode 23b, a second wiring section 25b extending in line in a direction substantially orthogonal to the common electrode 21 (in the vertical direction in FIG. 5) at the area between the substantially square pixel electrodes 23 a placed in the extending direction of the common electrode 21 (in the horizontal direction in FIG. 5), a third wiring section 25c extending obliquely in line from an end of the second wiring section 25b, and a fourth wiring section 25d extending in line in a direction substantially orthogonal to the common electrode 21 (in the vertical direction in FIG. 5) at the area between the substantially rectangular pixel electrodes 23b placed in the extending direction of the common electrode 21 (in the horizontal direction in FIG. 5). Consequently, two (two columns of) second wiring sections 25b, which extend in line in a direction substantially orthogonal to the common electrode 21 (in the vertical direction in FIG. 5), are placed at the area between the substantially square pixel electrodes 23a placed in the extending direction of the common electrode 21 (in the horizontal direction in FIG. 5), and two (two columns of) wiring sections, i.e., the second wiring section 24b and the fourth wiring section 25d, which extend in line in a direction substantially orthogonal to the common electrode 21 (in the vertical direction in FIG. 5) are placed at the area between the substantially rectangular pixel electrodes 23b placed in the extending direction of the common electrode 21 (in the horizontal direction in FIG. 5).

The two (two columns of) second wiring sections 25b placed between the substantially square pixel electrodes 23a and the two (two columns of) wiring sections, i.e., the second wiring section 24b and the fourth wiring section 25d, placed between the substantially rectangular pixel electrodes 23b, are located at the center in the areas between the left and right pixel electrodes, respectively.

That is, a distance d₁ between one substantially rectangular pixel electrode 23b (or substantially square pixel electrode 23a) and the second wiring section 24b (or second wiring section 25b) is equal to a distance d₂ between the other substantially rectangular pixel electrode 23b (or substantially square pixel electrode 23a) and the fourth wiring section 25d (or the second wiring section 25b). The second wiring section 24b, the second wiring section 25b, and the fourth wiring section 25d, arranged in two columns in the extending direction of the segment electrode (in the vertical direction), between the adjacent pixel electrodes 23a and between the adjacent pixel electrodes 23b (in the horizontal direction), are placed substantially in a line for each column. Moreover, as shown in FIG. 6, in the second wiring section 25b and the fourth wiring section 25d, placed substantially in a line as well as in the second wiring section 25b, and the second wiring section 24b, placed substantially in a line, an overlapping width d₃ is shared in the extending direction of the segment electrode 22 (in the vertical direction).

In the liquid crystal display device in this embodiment, there is also no difference in the influence of the shadows of the second wiring sections 24b and 25b, the fourth wiring sections 25d, etc. on the individual pixels, and the influence of the shadows on the individual pixels is uniform in every direction. Consequently, it is possible to prevent line display unevenness, and thereby a liquid crystal display device with satisfactory image quality can be produced in the same manner as that in the first or second embodiment. Furthermore, in this embodiment, since the substantially rectangular pixel electrode 23b is placed so as to spread over the upper and lower common electrodes 21, even if there is a slight misalignment between the common electrodes 21 and the segment electrodes 22, it is possible to avoid problems, such as a decrease in the contrast ratio of the image and degradation in resolution, thus maintaining a good quality image.

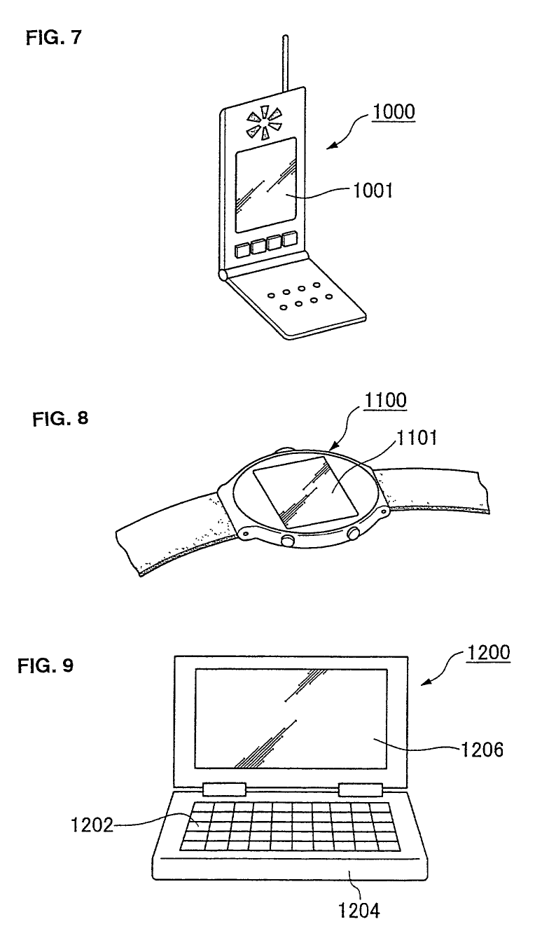

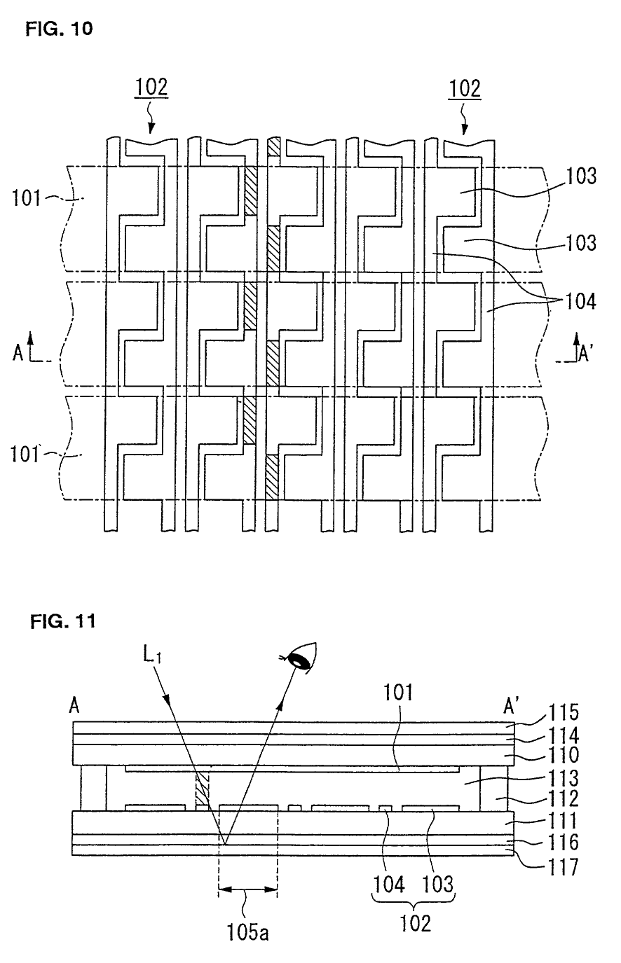

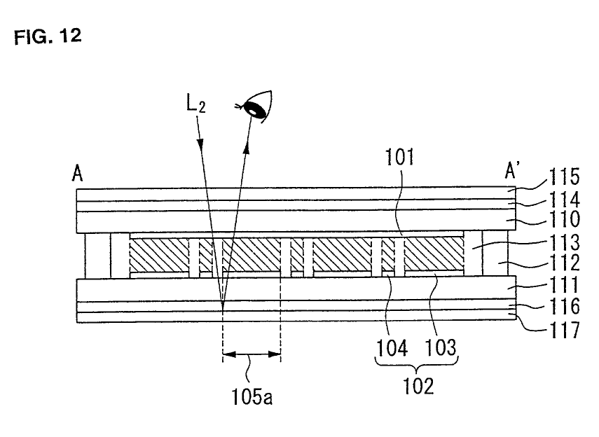

Examples of electronic apparatuses provided with the liquid crystal display devices according to the above-mentioned embodiments will be described. FIG. 7 is a perspective view of a mobile phone. FIG. 7 shows a mobile phone body 1000, and a liquid crystal display area 1001 using the liquid crystal display device.

FIG. 8 is a perspective view showing a wristwatch-type electronic apparatus. FIG. 8 shows a watch body 1100, and a liquid crystal display area 1101 using the liquid crystal display device.

FIG. 9 is a perspective view showing a mobile information processing apparatus, such as a word processor or a personal computer. FIG. 9 shows an information processing apparatus 1200, an input section 1202, such as a keyboard, information processing apparatus body 1204, and a liquid crystal display area 1206 using the liquid crystal display device.

Since the electronic apparatuses shown in FIGS. 7 to 9 are provided with the liquid crystal display areas using the liquid crystal display devices described in the embodiments, it is possible to produce electronic apparatuses provided with the screens having superior image quality with substantially no line display unevenness.

The present invention is not limited to the embodiments described above. It is to be understood that the invention is intended to cover various modifications within the scope of the invention while not deviating from the object of the invention. For example, in the embodiments described above, the first wiring section obliquely extends toward the second wiring section. However, in the present invention, among wiring sections, at least a section located between two adjacent pixel electrodes (namely, the second wiring section) needs to be placed at an equal distance from the two pixel electrodes and substantially in a line, and the first wiring section may have any shape. Although the double matrix and the triple matrix are described in the embodiments, the present invention is also applicable to liquid crystal display devices with a multiple matrix higher than the above.

As described above in detail, in the present invention, among wiring sections connecting pixel electrodes to each other, at least a section located between two adjacent pixel electrodes is placed at an equal distance from the two pixel electrodes, and the individual wiring sections are placed substantially in a line. Therefore, there is no difference in the influence of the shadows of the wiring sections on the individual pixels in the individual pixel lines, and the influence of the shadows on the individual pixels is uniform in every direction. Consequently, it is possible to prevent line display unevenness from occurring in the extending direction of the common electrodes, and thereby a reflective liquid crystal display device of a multiple matrix type having satisfactory image quality can be produced.

What is claimed is:

1. A liquid crystal display device of a multiple matrix type, comprising:
a pair of opposed substrates, each of the opposed substrates defining an outer surface;
a liquid crystal interposed between the pair of opposed substrates;
a plurality of rows of common electrodes provided on one of the substrates, each common electrode row defining a width direction and an extending direction;
a plurality of columns of segment electrodes provided on the substrate other than the one substrate so as to be cross to the plurality of rows of common electrodes, each segment electrode including a plurality of pixel electrodes and wiring sections connecting every predetermined number of the pixel electrodes to each other, a plurality of pixel electrodes facing one common electrode row and being arranged in the width direction of the one common electrode row so as to form displaying pixels, the wiring sections of the segment electrodes including a plurality of inter-pixel electrode wiring sections, each inter-pixel electrode wiring section being placed between two adjacent pixel electrodes at a substantially equal distance from the two adjacent pixel electrodes in the extending direction of the common electrodes, the plurality of inter-pixel electrode wiring sections being arranged substantially in a line in a direction substantially orthogonal to the extending direction of the common electrodes; and
a reflecting layer provided on the outer surface of at least one of the pair of opposed substrates.

2. A liquid crystal display device of a multiple matrix type, comprising:
a pair of opposed substrates, each of the opposed substrates defining an outer surface;
a liquid crystal interposed between the pair of opposed substrates;
a plurality of rows of common electrodes provided on one of the substrates, each common electrode row defining a width direction and an extending direction; and
a plurality of columns of segment electrodes provided on the substrate other than the one substrate so as to be cross to the plurality of rows of common electrodes, each segment electrode including a plurality of pixel electrodes and wiring sections connecting every predetermined number of the pixel electrodes to each other, a plurality of pixel electrodes facing one common electrode row and being arranged in the width direction of the one common electrode row so as to form displaying pixels, the wiring sections of the segment electrodes including a plurality of inter-pixel electrode wiring sections, each inter-pixel electrode wiring section being placed between two adjacent pixel electrodes at a substantially equal distance from the two adjacent pixel electrodes, the plurality of inter-pixel electrode wiring sections sharing an overlapping width in a direction substantially orthogonal to the extending direction of the common electrodes; and
a reflecting layer provided on an outer surface of at least one of the pair of substrates.

3. The liquid crystal display device according to claim 1, some of the pixel electrodes being placed so as to spread over two rows of common electrodes.

4. An electronic apparatus, comprising:
the liquid crystal display device according to claim 1.

5. The liquid crystal display device according to claim 2, some of the pixel electrodes being placed so as to spread over two rows of common electrodes.

6. An electronic apparatus, comprising:
the liquid crystal display device according to claim 2.
